(19) United States
(12) Patent Application Publication
(10) Pub. No.: US 2019/0243960 A1
(43) Pub. Date: Aug. 8, 2019

(54) ELECTRONIC APPARATUS WITH CLOCK AUTHENTICATION FUNCTION AND AUTHENTICATION METHOD OF CLOCK SIGNAL

(71) Applicant: MegaChips Corporation, Osaka (JP)

(72) Inventor: Atsuro YOSHIDA, Osaka (JP)

(73) Assignee: MegaChips Corporation, Osaka (JP)

(21) Appl. No.: 16/263,437

(22) Filed: Jan. 31, 2019

(30) Foreign Application Priority Data
Feb. 2, 2018 (JP) 2018-017068

(51) Int. Cl. G06F 21/44; G06F 1/12; G06F 7/58; G06F 1/08

(52) U.S. Cl. CPC G06F 21/44; G06F 1/08; G06F 7/582; G06F 1/12

(57) ABSTRACT

An electronic apparatus with a clock authentication function includes a first signal wire for a clock, a clock device, an electronic device, and an authentication unit. The clock device includes a clock generation unit containing circuitry configured to output a clock signal to the first signal wire and a first signal generation unit containing circuitry configured to generate a first signal synchronized with a clock signal generated by the clock generation unit. An electronic device includes an electronic circuit to which a clock signal is input via the first signal wire and a second signal generation unit containing circuitry configured to generate a second signal synchronized with a clock signal being input to the electronic circuit. The authentication unit includes circuitry configured to authenticate a clock signal being input to the electronic circuit based on whether or not the first signal and the second signal are synchronized with each other.

### CROSS-REFERENCE TO RELATED APPLICATIONS

The present application claims priority to Japanese Patent Application 2018-017068, filed by the Japanese Patent Office on Feb. 2, 2018, the entire contents of which being incorporated herein by reference.

### FIELD OF THE INVENTION

The present invention relates to an electronic apparatus with a clock authentication function and an authentication method of a clock signal.

### DESCRIPTION OF THE BACKGROUND ART

There is conventionally a technique that an illegal third party attacks an electronic circuit, thereby illegally acquiring confidential information stored in the electronic circuit. Examples of such an attack include a power analysis attack analyzing a consumed power of the electronic circuit, for example.

In the meanwhile, a technique of making such an acquisition of the confidential information difficult is also proposed (for example, Japanese Patent Application Laid-Open No. 2003-337750). For example, in Japanese Patent Application Laid-Open No. 2003-337750, a module includes a clock conversion mechanism and a submodule. A clock signal is input to the clock conversion mechanism. The clock conversion mechanism converts this clock signal, and outputs the converted clock signal to the submodule. More specifically, the clock conversion mechanism generates a pseudorandom number sequence based on the clock signal, and outputs this pseudorandom number sequence as the converted clock signal to the submodule. The submodule operates based on the input clock signal. Since a cycle of the converted clock signal irregularly changes, an operation timing of the submodule is hardly identified by a third party. Thus, it is hard to acquire the confidential information by the attack described above.

Also cited as techniques relating to the present application are Japanese Patent No. 5322144 and Japanese Patent Application Laid-Open No. 2013-80426.

### SUMMARY

An aspect of an electronic apparatus with a clock authentication function includes: a first signal wire for a clock; a clock device including a clock generation unit containing circuitry configured to output a clock signal to the first signal wire and a first signal generation unit containing circuitry configured to generate a first signal being synchronized with a clock signal being generated by the clock generation unit; an electronic device including an electronic circuit to which a clock signal is input via the first signal wire and a second signal generation unit containing circuitry configured to generate a second signal being synchronized with a clock signal being input to the electronic circuit; and an authentication unit including circuitry configured to authenticate a clock signal being input to the electronic circuit based on whether or not the first signal and the second signal are synchronized with each other.

An aspect of an authentication method of a clock signal is an authentication method of a clock signal in an electronic apparatus including a clock device and an electronic device being connected to each other via a first signal wire, comprising: a step that a clock generation unit of the clock device outputs a clock signal to a first signal wire; a step that a first synchronization signal generation unit of the clock device generates a first signal being synchronized with a clock signal being generated by the clock generation unit; a step that an electronic circuit of the electronic device operates based on a clock signal being input via the first signal wire; a step that a second synchronization signal generation unit of the electronic device generates a second signal being synchronized with a clock signal being input to the electronic circuit; and a step that a clock signal being input to the electronic circuit is authenticated based on whether or not the first signal and the second signal are synchronized with each other.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing schematically illustrating an example of a configuration of an electronic apparatus according to a first embodiment.

FIG. 2 is a drawing schematically illustrating an example of a configuration of an electronic apparatus provided with an illegal clock generation unit.

FIG. 3 is a drawing schematically illustrating an example of a configuration for achieving a function.

FIG. 4 is a drawing schematically illustrating an example of a more specific configuration of the electronic apparatus.

FIG. 5 is a flow chart illustrating an example of an operation of the electronic apparatus.

FIG. 6 is a flow chart illustrating an example of an operation of a clock device.

FIG. 7 is a drawing illustrating an example of a timing chart when a normal clock signal is input.

FIG. 8 is a drawing illustrating an example of a timing chart when an illegal clock signal is input.

FIG. 9 is a flow chart illustrating an example of an operation of a clock device.

FIG. 10 is a drawing schematically illustrating an example of a configuration of an electronic apparatus according to a second embodiment.

FIG. 11 is a drawing illustrating an example of a timing chart in an electronic apparatus to which a normal clock generation unit is connected.

FIG. 12 is a flow chart illustrating an example of an operation of the electronic apparatus.

FIG. 13 is a flow chart illustrating an example of an operation of a clock device.

FIG. 14 is a drawing illustrating an example of a timing chart when a normal clock signal is input.

FIG. 15 is a drawing illustrating an example of a timing chart when an illegal clock signal is input.

FIG. 16 is a drawing illustrating another example of a timing chart when a normal clock signal is input.

FIG. 17 is a drawing illustrating another example of a timing chart when an illegal clock signal is input.

### DESCRIPTION OF THE PREFERRED EMBODIMENTS

### First Embodiment

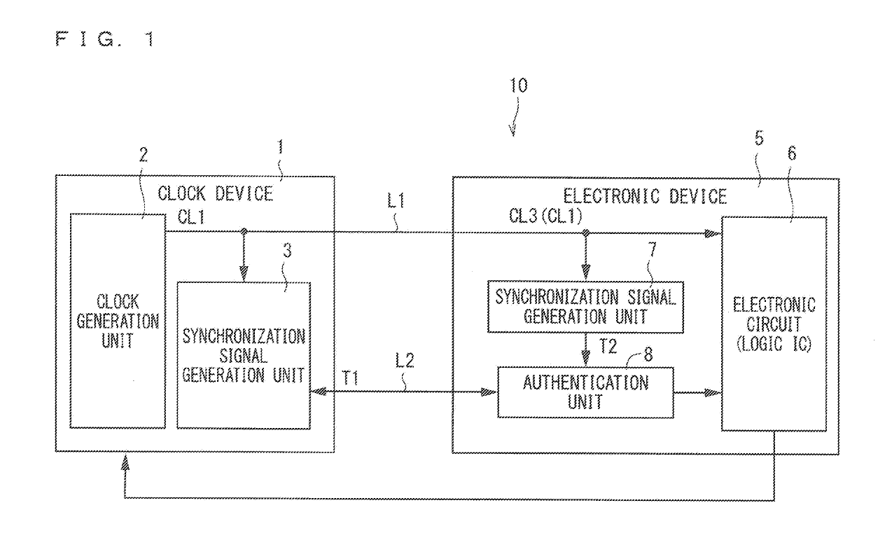

FIG. 1 is a functional block diagram illustrating an example of a schematic configuration of an electronic apparatus 10 with a clock authentication function (simply referred to as the electronic apparatus 10 hereinafter).

The electronic apparatus 10 includes a clock device 1 and an electronic device 5. The clock device 1 and the electronic device 5 are mutually connected via each of signal wires L1 and L2. The clock device 1 generates a clock signal CL1, and outputs the clock signal CL1 to the signal wire L1. The electronic device 5 operates based on the clock signal being input from the signal wire L1. Thus, the signal wire L1 is considered to be a signal wire for a clock transmitting the clock signal CL1. The signal wire L2 is a signal wire for authentication transmitting various types of signals used for an authentication of the clock signal as described hereinafter.

As illustrated in FIG. 1, the clock device 1 includes a clock generation unit 2 and a synchronization signal generation unit 3. The clock generation unit 2 generates a clock signal CL1, and outputs the clock signal CL1 to the signal wire L1. For example, the clock generation unit 2 has an oscillator such as a crystal oscillator, an LC oscillator, an RC oscillator, a ring oscillator, a ceramic oscillator, or a micro electro mechanical systems (MEMS) oscillator as an oscillation source. If the MEMS oscillator is applied as the oscillation source, characteristics of the output signal from the oscillator can be improved, and a size of the oscillator can be reduced.

The clock generation unit 2 generates the clock signal CL1 based on the periodic output signal being output from the oscillator. Herein, the clock generation unit 2 selectively outputs the clock signal CL1 whose cycle is substantially constant and the clock signal CL1 whose cycle irregularly changes. A specific example is described hereinafter.

For example, the clock generation unit 2 includes a phase locked loop (PLL) circuit appropriately performing a frequency dividing and/or a frequency multiplying of the output signal of the oscillator to generate the clock signal CL1. The cycle of this clock signal CL1 is substantially constant, for example.

The clock generation unit 2 includes a clock conversion mechanism as is the case in Japanese Patent Application Laid-Open No. 2003-337750. This clock conversion mechanism includes a pseudorandom number generation circuit, for example, and outputs a pseudorandom number sequence generated by the pseudorandom number generation circuit as the clock signal CL1. The cycle of this clock signal CL1 irregularly changes.

The clock generation unit 2 further includes a selection unit (a switch, for example) selecting the clock signal CL1 of substantially the constant cycle and the clock signal CL1 of the irregular cycle. To the selection unit, the clock signal CL1 of substantially the constant cycle is input from the PLL circuit, and the clock signal CL1 of the irregular cycle is input from the clock conversion mechanism. The selection unit selects the clock signal CL1 based on a request from the electronic device 5, and outputs the selected clock signal CL1 to the signal wire L1.

As illustrated in FIG. 1, the electronic device 5 includes an electronic circuit 6, a synchronization signal generation unit 7, and an authentication unit 8. The electronic circuit 6 operates based on the clock signal being input via the signal wire L1. The electronic circuit 6 is a logic integrated circuit (IC), for example. The electronic circuit 6 can perform processing using information with high secrecy (referred to as confidential information hereinafter) (referred to as confidential processing hereinafter). Examples of the confidential processing may include encryption processing and decoding processing, and examples of the confidential information may include an encryption key and a decoding key.

For example, the electronic circuit 6 receives first code text data from outside not shown, and performs the decoding processing on the first code text data with a predetermined key (a decoding key), thereby generating first plain text data. The electronic circuit 6 performs the encryption processing on second plain text data with a predetermined key (an encryption key), thereby generating second code text data, and outputs the second code text data to the outside. An algorithm used in such encryption processing and decoding processing needs not be particularly limited, however, advanced encryption standard (AES) can be adopted, for example.

The electronic circuit 6 can also perform normal processing different from the confidential processing. The normal processing is processing using information with lower secrecy than the confidential information. A type of the normal processing needs not be limited, but may include image processing, for example.

The electronic circuit 6 transmits a request of the clock signal CL1 of substantially the constant cycle to the clock device 1 in performing the normal processing, and transmits a request of the clock signal CL1 of the irregular cycle to the clock device 1 in performing the confidential processing. The clock generation unit 2 outputs the clock signal CL1 to the signal wire L1 based on the request.

If the electronic circuit 6 performs the confidential processing (for example, the encryption processing or the decoding processing) based on the clock signal CL1 of the irregular cycle, each procedure in the confidential processing is performed at an irregular timing. Accordingly, the third party hardly identifies the timing, and hardly acquires the confidential information even if the third party performs an illegal attack (a power analysis attack, for example).

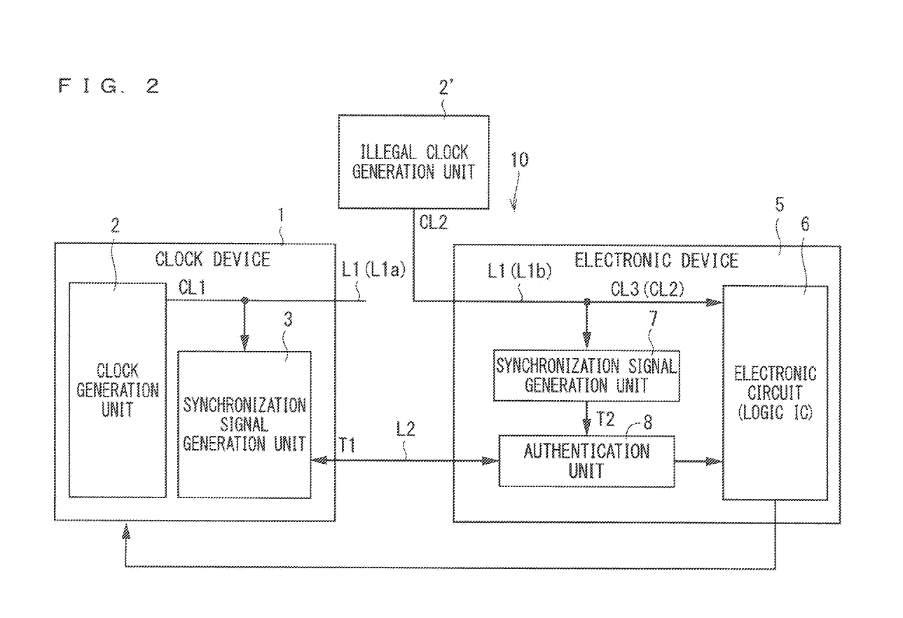

However, it is considered that the third party separately prepares an illegal clock generation unit for purpose of invalidating the clock signal CL1 of the irregular cycle. FIG. 2 is a drawing schematically illustrating an example of a configuration of the electronic apparatus 10 provided with an illegal clock generation unit. In the example in FIG. 2, the signal wire L1 is disconnected between the clock device 1 and the electronic device 5, and signal wires L1a and L1b are formed. The signal wire L1a constitutes a part of the disconnected signal wire L1 connected to the clock generation unit 2, and the signal wire L1b constitutes a part of the disconnected signal wire L1 connected to the electronic circuit 6.

An illegal clock generation unit 2′ is connected to the signal wire L1b by the third party. The illegal clock generation unit 2′ outputs an illegal clock signal CL2 of substantially the constant cycle to the signal wire Llb. In this case, the electronic circuit 6 operates based on the illegal clock signal CL2. If the electronic circuit 6 performs the confidential processing based on the clock signal CL2 of substantially the constant cycle, the confidential information is easily leaked by the illegal attack performed by the third party.

Thus, as illustrated in FIG. 1 and FIG. 2, the electronic apparatus 10 is provided with the synchronization signal generation units 3 and 7 and the authentication unit 8 for authenticating the clock signal.

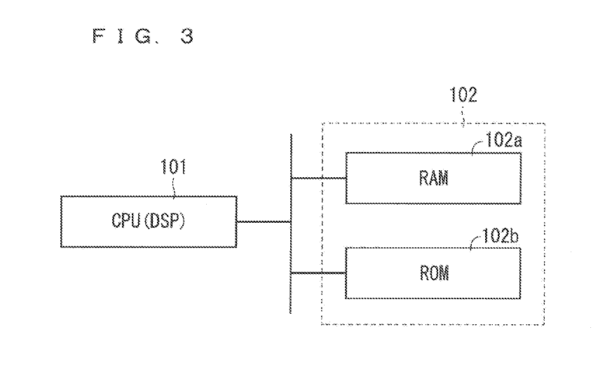

Functions of the synchronization signal generation units 3 and 7 and the authentication unit 8 are described hereinafter. The functions of the synchronization signal generation units 3 and 7 and the authentication unit 8 may be achieved by software, for example. FIG. 3 schematically illustrates an example of a configuration of achieving the functions with the software. As illustrated in FIG. 3, the configuration includes an arithmetic processing unit 101 and a storage medium 102, for example. The arithmetic processing unit 101 is a processing unit such as a central processing unit (CPU) or a digital signal processor (DSP), for example, and the storage medium 102 includes a random access memory (RAM) 102a providing an operation region of the arithmetic processing unit 101 and a read only memory (ROM) 102b storing a program and data, for example. If the arithmetic processing unit 101 reads out and performs the program stored in the storage medium 102, various functions are achieved.

A part or all of the functions of each of the synchronization signal generation units 3 and 7 and the authentication unit 8 need not be necessarily achieved by software, but may be achieved by a hardware circuit. That is to say, each of the synchronization signal generation units 3 and 7 and the authentication unit 8 is achieved by a circuit group (circuitry) formed of hardware, software, or a composition of them, for example. If a hardware circuit is used, the functions can be achieved by an operation of a dedicated circuit including a logic circuit, for example. A function unit made up of the hardware circuit can achieve high responsiveness.

The synchronization signal generation unit 3 is connected to the signal wire L1 in the clock device 1. Thus, the clock signal CL1 being output from the clock generation unit 2 is input to the synchronization signal generation unit 3. The synchronization signal generation unit 3 generates a signal T1 for authentication synchronized with the clock signal CL1 (referred to as the authentication signal T1 hereinafter), and outputs the authentication signal T1 to the authentication unit 8 via the signal wire L2. A specific example of the synchronization signal generation unit 3 is described hereinafter.

The synchronization signal generation unit 7 is connected to the signal wire L1 in the electronic device 5. Thus, the same clock signal as the clock signal being input to the electronic circuit 6 is input to the synchronization signal generation unit 7. The clock signal being input to the electronic circuit 6 is referred to as a clock signal CL3 hereinafter. If a normal clock signal CL1 is input to the electronic circuit 6, the clock signal CL3 is the normal clock signal CL1, and if an illegal clock signal CL2 is input to the electronic circuit 6, the clock signal CL3 is the illegal clock signal CL2.

The synchronization signal generation unit 7 generates a signal T2 for authentication synchronized with the clock signal CL3 (referred to as the authentication signal T2 hereinafter). Thus, the synchronization signal generation unit 7 generates the authentication signal T2 synchronized with the normal clock signal CL1 when the normal clock signal CL1 is input to the electronic circuit 6, and the synchronization signal generation unit 7 generates the authentication signal T2 synchronized with the illegal clock signal CL2 when the illegal clock signal CL2 is input to the electronic circuit 6.

To the authentication unit 8, the authentication signal T2 is input from the synchronization signal generation unit 7 in the electronic device 5, and the authentication signal T1 is input from the synchronization signal generation unit 3 via the signal wire L2. The authentication unit 8 authenticates the clock signal CL3 being input to the electronic circuit 6 based on whether or not the authentication signals T1 and T2 are mutually synchronized. Specifically, the authentication unit 8 determines that the clock signal CL3 is the normal clock signal CL1 when the authentication signals T1 and T2 are synchronized, and determines that the clock signal CL3 is the illegal clock signal CL2 when the authentication signals T1 and T2 are not synchronized.

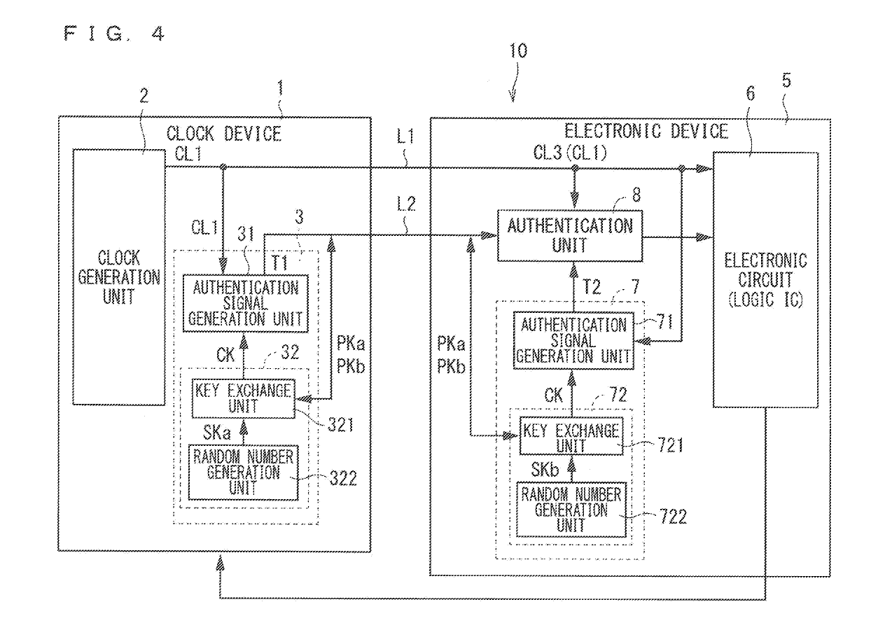

FIG. 4 is a drawing illustrating an example of a more specific configuration of the electronic apparatus 10. FIG. 4 illustrates an example of a specific inner configuration of the synchronization signal generation units 3 and 7. The synchronization signal generation unit 3 includes an authentication signal generation unit 31 and a setting value generation unit 32, and the synchronization signal generation unit 7 includes an authentication signal generation unit 71 and a setting value generation unit 72.

The setting value generation units 32 and 72 generate an initial setting value in common with each other. The initial setting value is used in the authentication signal generation units 31 and 71 described in detail hereinafter. The setting value generation units 32 and 72 generate, as the initial setting value, a common key using a key exchange of a public-key cryptography system, for example, as a key generation algorithm. Diffie-Hellman key exchange, for example, can be used for the algorithm. The common key is not used as an encryption key or a decoding key of a confidentiality algorithm of common key cryptosystem or public key cryptosystem, but used as the initial setting value of the authentication signal generation units 31 and 71. Herein, each value described hereinafter is referred to as “the key” for convenience by reason that the initial setting value is generated with a key generation algorithm, but needs not actually function as “the key”.

The setting value generation unit 32 includes a key exchange unit 321 and a random number generation unit 322, and the setting value generation unit 72 includes a key exchange unit 721 and a random number generation unit 722.

The random number generation unit 322, which is a random number generation circuit, generates a random number value as a secret key SKa, and outputs the secret key SKa to the key exchange unit 321. The random number generation unit 722, which is a random number generation circuit, generates a random number value as a secret key SKb, and outputs the secret key SKb to the key exchange unit 721.

The key exchange unit 321 generates a public key PKa based on the secret key SKa and base parameters X and p. The base parameters X and p are preset, for example, and stored in a storage medium of the clock device 1. For example, the base parameter X is a small integral number, and the base parameter p is a large prime number. The key exchange unit 321 calculates (X\hat{ }SKa mod p), and generates a calculation result thereof as the public key PKa, for example. Herein, “A\hat{ }B” indicates a power of A including B as index, and “A mod B” indicates a remainder when A is divided by B. The key exchange unit 321 outputs the public key PKa to the key exchange unit 721 of the electronic device 5 via the signal wire L2.

The key exchange unit 721 generates a public key PKb based on the secret key SKb and base parameters X and p. The base parameters X and p are also stored in the storage medium of the electronic device 5. The key exchange unit 721 calculates (X\hat{ }SKb mod p), and generates a calculation result thereof as a public key PKb, for example. The key exchange unit 721 outputs the public key PKb to the key exchange unit 321 of the clock device 1 via the signal wire L2.

The key exchange unit 321 generates a common key CK based on the secret key SKa and the public key PKb, and outputs the common key CK as the initial setting value to the authentication signal generation unit 31. Specifically, the key exchange unit 321 calculates (PKb\hat{ }SKa mod p), for example, and generates a calculation result thereof as the common key CK. The key exchange unit 721 generates a common key CK based on the secret key SKb and the public key PKa, and outputs the common key CK as the initial setting value to the authentication signal generation unit 71. Specifically, the key exchange unit 721 calculates (PKa\hat{ }SKb mod p), for example, and generates a calculation result thereof as the common key CK. Since (PKb\hat{ }SKa mod p) and (PKa\hat{ }SKb mod p) include the same value, the setting value generation units 32 and 72 generate the common common key CK (the initial setting value), respectively.

The clock signal CL1 is input from the clock generation unit 2 to the authentication signal generator 31 and the common key CK is input from the key exchange unit 321 to the authentication signal generation unit 31, in the clock device 1. The authentication signal generation unit 31 repeatedly performs the calculation processing with a predetermined algorithm in synchronization with the clock signal CL1, using the common key CK as the initial setting value, to generate the authentication signal T1. The initial setting value indicates an initial variable in the predetermined algorithm, for example. For example, the authentication signal generation unit 31 may generate (or update) the authentication signal T1 with an algorithm including a previous authentication signal T1 as a variable. The value of the authentication signal T1 changes in synchronization with the clock signal CL1.

As a more specific example, the authentication signal generation unit 31 may include a first pseudorandom number generation circuit generating a pseudorandom number value with the predetermined algorithm as the authentication signal T1. The common key CK is input as the initial setting value to the first pseudorandom number generation circuit, and the clock signal CL1 is also input. The first pseudorandom number generation circuit sequentially generates the pseudorandom number value (the authentication signal T1) in synchronization with the clock signal CL1. The authentication signal generation unit 31 outputs the authentication signal T1 to the authentication unit 8 via the signal wire L2.

The clock signal CL3 is input via the signal wire L1 and the common key CK is input from the key exchange unit 721 to the authentication signal generation unit 71 in the electronic device 5. The authentication signal generation unit 71 repeatedly performs the calculation processing with the same algorithm as that of the authentication signal generation unit 31 in synchronization with the clock signal CL3, using the common key CK as the initial setting value, to generate the authentication signal T2. Thus, the value of the authentication signal T2 changes in synchronization with the clock signal CL3.

As a more specific example, the authentication signal generation unit 71 includes a second pseudorandom number generation circuit which is the same as the first pseudorandom number generation circuit of the authentication signal generation unit 31. The common key CK is input as the initial setting value to the second pseudorandom number generation circuit, and the clock signal CL3 is also input. The second pseudorandom number generation circuit sequentially generates the pseudorandom number value (the authentication signal T2) in synchronization with the clock signal CL3 with the same algorithm as that of the first pseudorandom number generation circuit. The authentication signal generation unit 71 outputs the authentication signal T2 to the authentication unit 8.

If the normal clock signal CL1 is input to the authentication signal generation unit 71, the authentication signals T1 and T2 generated by the authentication signal generation units 31 and 71, respectively, change in synchronization with each other. That is to say, the authentication signals T1 and T2 always take the same value as an ideal.

In the meanwhile, if the illegal clock signal CL2 is input to the authentication signal generation unit 71, the authentication signals T1 and T2 generated by the authentication signal generation units 31 and 71, respectively, are not synchronized with each other. That is to say, each of the authentication signals T1 and T2 eventually takes a value different from each other.

Then, the authentication unit 8 determines whether or not the authentication signals T1 and T2 are synchronized with each other based on the authentication signals T1 and T2. More specifically, the authentication unit 8 determines whether or not the value of the authentication signals T1 and T2 are equal to each other. If the values of the authentication signals T1 and T2 are equal to each other, that is to say, if the authentication signals T1 and T2 are synchronized with each other, the authentication unit 8 determines that the clock signal CL3 being input to the electronic circuit 6 is the normal clock signal CL1. In the meanwhile, if the values of the authentication signals T1 and T2 are not equal to each other, that is to say, if the authentication signals T1 and T2 are not synchronized with each other, the authentication unit 8 determines that the clock signal CL3 being input to the electronic circuit 6 is the illegal clock signal CL2.

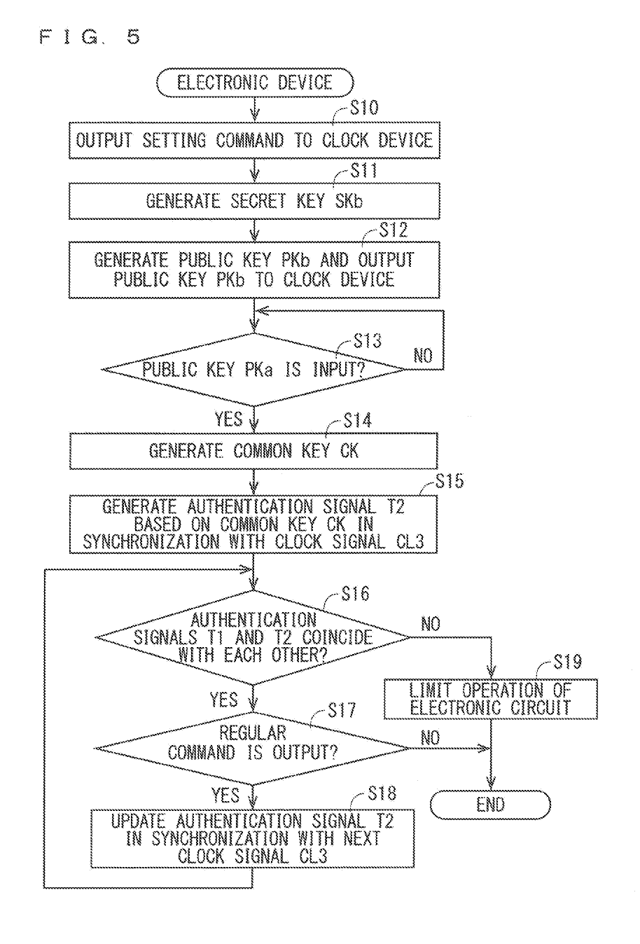

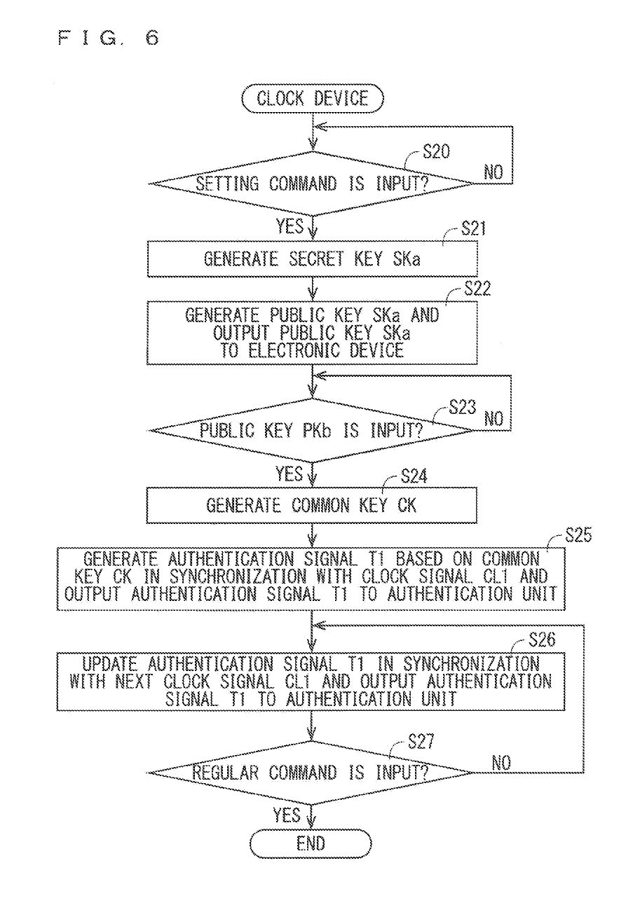

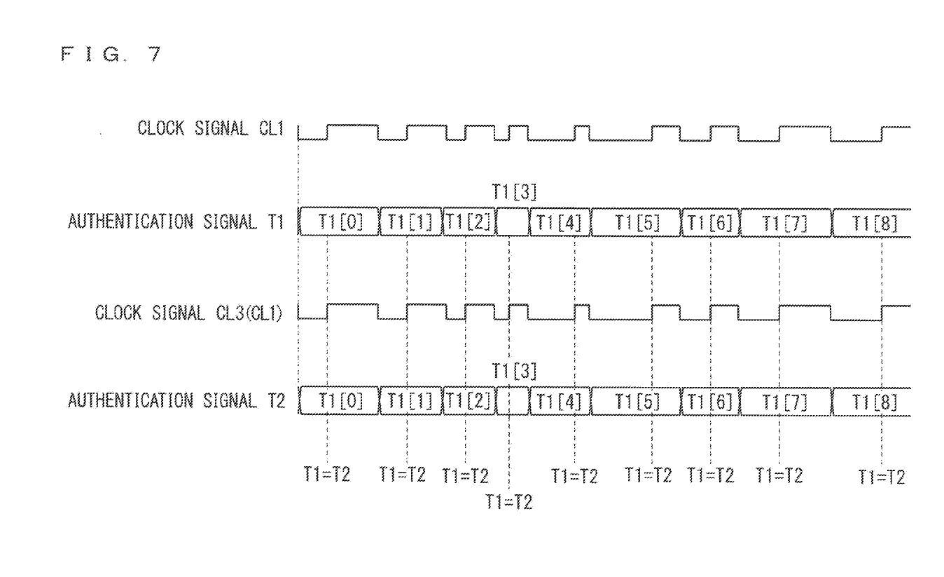

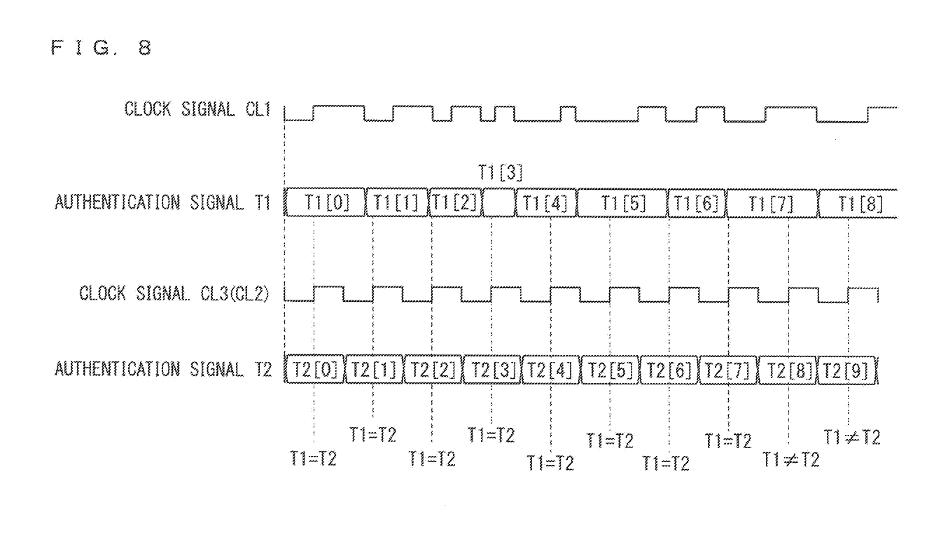

Each of FIG. 5 and FIG. 6 is a flow chart illustrating an example of a specific operation of the electronic apparatus 10. FIG. 5 illustrates an example of the operation of the electronic device 5, and FIG. 6 illustrates an example of the operation of the clock device 1. Each of FIG. 7 and FIG. 8 is a drawing illustrating an example of a timing chart of the electronic apparatus 10. FIG. 7 illustrates the timing chart when the normal clock signal CL1 is input to the electronic circuit 6, and FIG. 8 is the timing chart when the illegal clock signal CL2 is input to the electronic circuit 6.

With reference to FIG. 5, in Step S10 firstly, the electronic circuit 6 outputs a command of instructing the generation of the initial setting value (referred to as the setting command hereinafter) to the clock device 1, for example. For example, the electronic circuit 6 outputs the setting command prior to the confidential processing at the time of switching from the normal processing to the confidential processing. The clock device 1 performs the generation processing of the initial setting value in accordance with the input of the setting command (Steps S21 to S24 in FIG. 6: described hereinafter). The electronic device 5 also performs the generation processing of the initial setting value (Steps S11 to S14) in accordance with the setting command.

In Step S11, the random number generation unit 722 generates a random number value as a secret key SKb, and outputs the secret key SKb to the key exchange unit 721. Next, in Step S12, the key exchange unit 721 generates a public key PKb based on the secret key SKb and base parameters X and p, for example, and outputs the public key PKb to the key exchange unit 321 of the clock device 1.

Next, in Step S13, the key exchange unit 721 determines whether or not the public key PKa is input from the clock device 1. If the public key PKa has not been input yet, the key exchange unit 721 performs Step S13 again. If the public key PKa is input, the key exchange unit 721 generates the common key CK based on the secret key SKb and the public key PKa in Step S14, and outputs the common key CK to the authentication signal generation unit 71.

Next, an example of the operation of the clock device 1 is described. With reference to FIG. 6, the clock device 1 determines whether or not the setting command is input from the electronic device 5 in Step S20. If the setting command has not been input yet, the clock device 1 performs Step S20 again.

If the setting command is input, the random number generation unit 322 generates a random number value as a secret key SKa in Step S21, and outputs the secret key SKa to the key exchange unit 321. Next, in Step S22, the key exchange unit 321 generates a public key PKa based on the secret key SKa and base parameters X and p, for example, and outputs the public key PKa to the key exchange unit 721 of the electronic device 5.

Next, in Step S23, the key exchange unit 321 determines whether or not the public key PKb is input from the key exchange unit 721 of the electronic device 5. If the public key PKb has not been input yet, the key exchange unit 321 performs Step S23 again. If the public key PKb is input, the key exchange unit 321 generates the common key CK based on the secret key SKa and the public key PKb in Step S24, and outputs the common key CK to the authentication signal generation unit 31.

As described above, the common initial setting value (the common key CK) for generating the authentication signals T1 and T2 can be generated in Steps S11 to S14 and Steps S21 to S24.

The sequential processing of Steps S11 to S14 and S21 to S24 corresponds to the processing of generating the initial setting value prior to the clock authentication. In the processing prior to the clock authentication, the actual clock authentication (Steps S15 to S19 and S25 to S27 described hereinafter) is not performed, thus the electronic circuit 6 may perform the confidential processing after finishing the processing prior to the clock authentication. Accordingly, the clock authentication can be performed immediately after starting the confidential processing, thus the leakage of the confidential information can be suppressed more reliably.

As described above, the electronic circuit 6 transmits the request of the clock signal CL1 of the irregular cycle to the clock device 1 at the time of switching from the normal processing to the confidential processing. If the electronic circuit 6 performs the confidential processing after the processing of generating the initial setting value, the request may be transmitted after the processing of generating the initial setting value. That is to say, when the processing prior to the clock authentication is finished, the electronic circuit 6 may output the command of requesting the clock signal CL1 of the irregular cycle (referred to as the irregular command hereinafter) to the clock device 1 and subsequently perform the confidential processing. The clock generation unit 2 outputs clock signal CL1 of the irregular cycle to the signal wire L1 in response to the irregular command. If the clock signal CL1 is appropriately input to the electronic circuit 6, the electronic circuit 6 can perform the confidential processing based on the clock signal CL1 of the irregular cycle.

In Step S25, the authentication signal generation unit 31 generates the authentication signal T1 based on the common key CK in synchronization with the clock signal CL1, and outputs the authentication signal T1 to the authentication unit 8 via the signal wire L2. For example, the authentication signal generation unit 31 generates the pseudorandom number value (the authentication signal T1) using the common key CK as the initial setting value. In the illustrations in FIG. 7 and FIG. 8, the authentication signal generation unit 31 generates the authentication signal T1 [0] in synchronization with a fall of the clock signal CL1.

Next, in Step S26, the authentication signal generation unit 31 updates the authentication signal T1 in synchronization with a next fall of the clock signal CL1, for example, and outputs the authentication signal T1 to the authentication unit 8 via the signal wire L2. In the examples in FIG. 7 and FIG. 8, the authentication signal T1 after the update is indicated by the authentication signals T1 [1], . . . , T1 [8].

Next, in Step S27, the clock device 1 determines whether or not the regular command is input from the electronic device 5. The regular command is a command for instructing the output of the clock signal CL1 of substantially the constant cycle, and is output by the electronic circuit 6 at the time of switching from the confidential processing to the normal processing, for example. If the regular command has not been input yet, the authentication signal generation unit 31 performs Step S26 again. In the meanwhile, if the regular command is input, the clock device 1 finishes the authentication processing of the clock signal, and outputs the clock signal CL1 of substantially the constant cycle to the signal wire L1. That is to say, herein, the clock device 1 performs the authentication processing of the clock signal over the period of performing the confidential processing, and does not perform the authentication processing of the clock signal in the period of performing the normal processing.

An example of the operation of the electronic device 5 is described again. With reference to FIG. 5, in Step S15 subsequent to Step S14, the authentication signal generation unit 71 generates the authentication signal T2 based on the common key CK in synchronization with the clock signal CL3, and outputs the authentication signal T2 to the authentication unit 8. For example, the authentication signal generation unit 71 generates the pseudorandom number value (the authentication signal T2) using the common key CK as the initial setting value. In the illustrations in FIG. 7 and FIG. 8, the authentication signal generation unit 71 generates the authentication signal T2 [0] in synchronization with a fall of the clock signal CL3. Since the authentication signal generation unit 71 generates the authentication signal T2 with the same algorithm and the same initial setting value as those of the authentication signal generation unit 31, the values of the authentication signals T1 [0] and T2 [0] coincide with each other.

Next in Step S16, the authentication unit 8 determines whether or not the authentication signals T1 and T2 coincide with each other. For example, the authentication unit 8 performs this determination in synchronization with a rise of the clock signal CL3. If the authentication signals T1 and T2 coincide with each other, the authentication unit 8 determines whether or not the regular command is output to the clock device 1 in Step S17. If the regular command is output, the authentication unit 8 finishes the authentication processing of the clock signal.

If the regular command is not output, the authentication signal generation unit 71 updates the authentication signal T2 in synchronization with a next fall of the clock signal CL3, for example, in Step S18, and outputs the authentication signal T2 to the authentication unit 8. For example, the authentication signal generation unit 71 generates the pseudorandom number value as the authentication signal T2. Next, the authentication unit 8 performs Step S16 again.

In the examples in FIG. 7 and FIG. 8, the authentication signal T2 after the update is indicated by the authentication signals T2 [1], . . . , T2 [8] (or T2 [9]). Since the authentication signal generation unit 71 updates the authentication signal T2 with the same algorithm as that of the authentication signal generation unit 31, the values of the authentication signals T1 [n] and T2 [n] (n is an integral number) coincide with each other.

If the clock signal CL3 is the normal clock signal CL1, the authentication signals T1 [n] and T2 [n] are updated in synchronization with each other, thus the authentication signals T1 and T2 at an optional timing coincide with each other as an ideal (FIG. 7). In the meanwhile, if the clock signal CL3 is the illegal clock signal CL2, the authentication signals T1 [n] and T2 [n] are updated in asynchronization with each other. Thus, the authentication signals T1 and T2 at the same point of time are eventually different from each other (FIG. 8).

Thus, in Step S16 eventually, the authentication unit 8 determines that the values of the authentication signals T1 and T2 do not coincide with each other. For example, in the example in FIG. 8, the authentication signals T1 [7] an T2 [8] at a certain point of time when the clock signal CL3 falls are different from each other, and at this time, the authentication unit 8 determines that the authentication signals T1 and T2 do not coincide with each other. If the values of the authentication signals T1 and T2 do not coincide with each other, the authentication unit 8 determines that the clock signal CL3 is the illegal clock signal CL2 in Step S19, and limits the operation of the electronic circuit 6. For example, the authentication unit 8 finishes the operation of the electronic circuit 6. More specifically, if the electronic circuit 6 includes a reset terminal, for example, the authentication unit 8 may output a reset signal to the electronic circuit 6.

As described above, if the authentication signals T1 and T2 coincide with each other, the authentication unit 8 determines that the clock signal CL3 is the normal clock signal CL1, and continues the authentication processing of the clock signal without performing Step S19 (Steps S16 to S18), and if the authentication signals T1 and T2 do not coincide with each other, the authentication unit 8 determines that the clock signal CL3 is the illegal clock signal CL2, and limits the operation of the electronic circuit 6 (Steps S16 and S19). This configuration can make it difficult for the illegal third party to acquire the confidential information. More generally speaking, since the operation of the electronic circuit 6 based on the illegal clock signal CL2 is limited, a benefit which the illegal third party can acquire can be suppressed.

In the example described above, the common key CK is adopted as the initial setting value being input to the authentication signal generation units 31 and 71 in common. Thus, the secrecy of the initial setting value can be improved. This configuration can increase a level of the clock authentication. If the authentication signal generation units 31 and 71 include the pseudorandom number generation circuit, the authentication signals T1 and T2 are randomly updated in synchronization with the clock signals CL1 and CL3, respectively. This configuration makes it difficult for the third party to predict the authentication signals T1 and T2, thus the level of the clock authentication can be further increased.

In the example described above, the authentication processing of the clock signal is performed in the period of performing the confidential processing, and is not performed in the period of performing the normal processing. According to this configuration, the authentication processing of the clock signal is performed only in a state where the confidential information is easily leaked. Thus, the consumed power of the electronic apparatus 10 can be reduced while efficiently suppressing the leakage of the confidential information. If there is a low necessity of reducing the consumed power, the authentication processing of the clock signal may be performed in the period of performing the normal processing.

### Second Embodiment

In the specific example of the first embodiment, a random number value is adopted as the authentication signal T1 being output from the clock device 1 to the electronic device 5. Thus, this authentication signal T1 includes at least an information amount sufficient to express the random number value. The second embodiment intends to reduce the information amount of the signal being output from the clock device 1 to the electronic device 5.

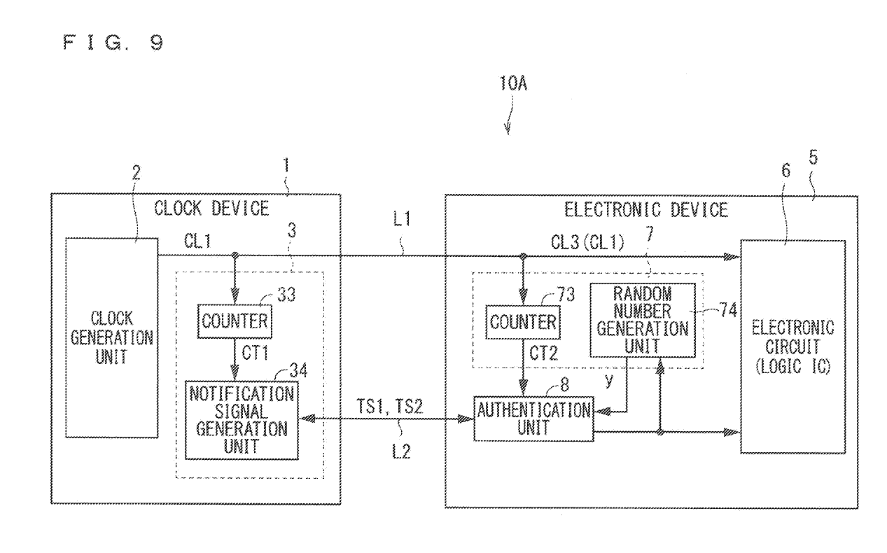

An example of the configuration of the electronic apparatus 10A according to the second embodiment is similar to that of the electronic apparatus 10 in FIG. 1. However, the operations of the synchronization signal generation units 3 and 7 and the authentication unit 8 are different. FIG. 9 is a drawing schematically illustrating an example of a configuration of the electronic apparatus 10A according to the second embodiment.

<Summary of Clock Authentication>

A point of view of the clock authentication according to the second embodiment is briefly described first. As described above, if the clock signal CL3 being input to the electronic circuit 6 is the illegal clock signal CL2, the cycle of the clock signal CL3 is different from the cycle of the normal clock signal CL1. Thus, in this case, numbers of cycles of the clock signals CL1 and CL3 are gradually deviated from a reference point of time by lapse of time (also see FIG. 8). For example, in FIG. 8, the period of eighth cycle of the clock signal CL1 does not temporally overlap with the period of the eighth cycle of the clock signal CL3. In the meanwhile, if the clock signal CL3 is the normal clock signal CL1, the numbers of cycles of the clock signals CL1 and CL3 always naturally coincide with each other regardless of the lapse of time as an ideal (also see FIG. 7).

In the second embodiment, the clock device 1 outputs a notification signal TS1 to the electronic device 5 in the period of y^{th} (y is a natural number) cycle of the clock signal CL1. The information amount of the notification signal TS1 is smaller than the information amount of the authentication signal T1, and may be 1 bit, for example.

If the clock signal CL3 is the normal clock signal CL1, the electronic device 5 receives the notification signal TS1 in the period of the y^{th} cycle of the clock signal CL3, and if the clock signal CL3 is the illegal clock signal CL1, the electronic device 5 does not receive the notification signal TS1 in the period of the y^{th} cycle of the clock signal CL3. Thus, the electronic device 5 determines whether or not the electronic device 5 receives the notification signal TS1 in the period of the y^{th} cycle of the clock signal CL3, and if the electronic device 5 receives the notification signal TS1 in the period described above, the electronic device 5 determines that the clock signal CL3 is the normal clock signal CL1. If the electronic device 5 does not receive the notification signal TS1 in the period described above, the electronic device 5 determines that the clock signal CL3 is the illegal clock signal CL2.

<Detail of Electronic Apparatus>

As illustrated in FIG. 9, the synchronization signal generation unit 3 includes a counter 33 and a notification signal generation unit 34, and the synchronization signal generation unit 7 includes a counter 73 and a random number generation unit 74.

The counter 33 is connected to the signal wire L1 in the clock device 1, and the clock signal CL1 generated by the clock generation unit 2 is input to the counter 33. The counter 33 counts the clock signal CL1 to generate a count value CT1, and outputs the count value CT1 to the notification signal generation unit 34. The count value CT1 is a signal synchronized with the clock signal CL1. The counter 33 may perform a count-up operation, or may also perform a count-down operation. That is to say, the counter 33 may increment the count value CT1 for each cycle of the clock signal CL1, or may decrement the count value CT1 for each cycle of the clock signal CL1. A count amount counted by the counter 33 indicates the number of cycles of the clock signal CL1 from a point of time when the counter 33 is initialized.

The counter 73 is connected to the signal wire L1 in the electronic device 5, and the clock signal CL3 being input to the electronic circuit 6 is input to the counter 73. The counter 73 counts the clock signal CL3 to generate a count value CT2, and outputs the count value CT2 to the authentication unit 8. The count value CT2 is a signal synchronized with the clock signal CL3. The counter 73 may perform a count-up operation, or may also perform a count-down operation. That is to say, the counter 73 may increment the count value CT2 for each cycle of the clock signal CL3, or may decrement the count value CT2 for each cycle of the clock signal CL3. A count amount counted by the counter 73 indicates the number of cycles of the clock signal CL3 from a point of time when the counter 73 is initialized.

The counters 33 and 73 are initialized in synchronization with each other, and start the count operation, respectively. An example of a specific timing of the initialization is described hereinafter.

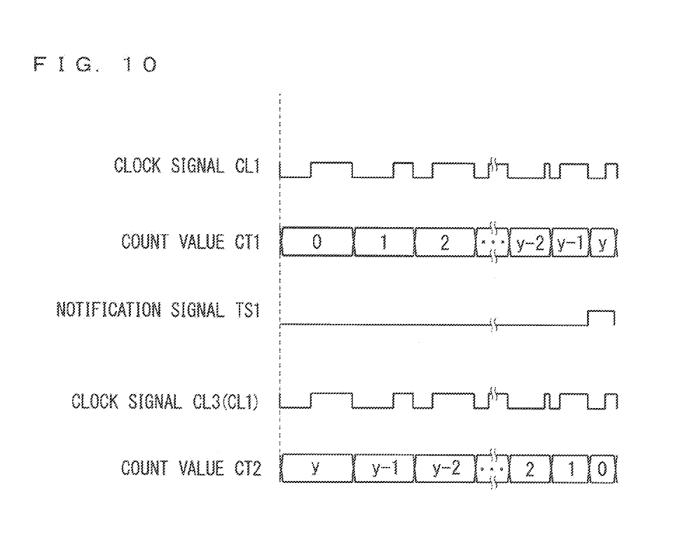

The notification signal generation unit 34 outputs the notification signal TS1 when the count amount of the counter 33 takes a certain value y. FIG. 10 illustrates an example of a timing chart of the electronic apparatus 10A. FIG. 10 illustrates a timing chart in a case where the normal clock signal CL1 is input to the electronic device 5. In the example in FIG. 10, the count values CT1 and CT2 are initialized to zero and the value y, respectively. The count value CT1 is incremented in synchronization with the fall of the clock signal CL1, and the count value CT2 is decremented in synchronization with the fall of the clock signal CL3.

When the count amount of the counter 33 takes the value y, the count value CT1 takes the value y, thus the notification signal generation unit 34 outputs the notification signal TS1 to the authentication unit 8 in the period when the count value CT1 takes the value y. Accordingly, the notification signal TS1 is output in the period of the y^{th} cycle of the clock signal CL1. In the example in FIG. 10, the output of the notification signal TS1 is indicated by the notification signal TS1 taking H (high).

The authentication unit 8 determines whether or not the notification signal TS1 is input in the period when the count amount of the counter 73 takes the value y. In the illustration in FIG. 10, the count value CT2 of the counter 73, taking the value y as the initial value, is decremented, thus when the count value CT2 takes zero, the count amount of the counter 73 takes the value y. Thus, the authentication unit 8 may determine whether or not the notification signal TS1 is input in the period when the count value CT2 takes zero. If the notification signal TS1 is input in the period described above, the authentication unit 8 determines that the clock signal CL3 is the normal clock signal CL1, and if the notification signal TS1 is not input in the period described above, the authentication unit 8 determines that the clock signal CL3 is the illegal clock signal CL2.

<Authentication Value y>

The value y described above may be preset, for example, and stored in a storage medium in each of the clock device 1 and the electronic device 5. However, the electronic device 5 generates the value y (referred to as the authentication value y hereinafter) and transmits the authentication value y to the clock device 1 herein. A summary of the generation and a method of transmitting the authentication value y is described hereinafter first. Subsequently, an example of a more specific operation of the electronic apparatus 10 is described together with the authentication operation described above.

In the illustration in FIG. 9, the synchronization signal generation unit 7 includes the random number generation unit 74 generating the value y (also referred to as the authentication value y hereinafter). The random number generation unit 74, which is a random number generation circuit, generates the random number value as the authentication value y, and outputs the authentication value y to the authentication unit 8.

The authentication unit 8 transmits the authentication value y to the notification signal generation unit 34 of the clock device 1 via the signal wire L2. However, the authentication value y is not output directly, but the authentication value y is transmitted to the notification signal generation unit 34 using the cycles of the clock signals CL1 and CL3 herein.

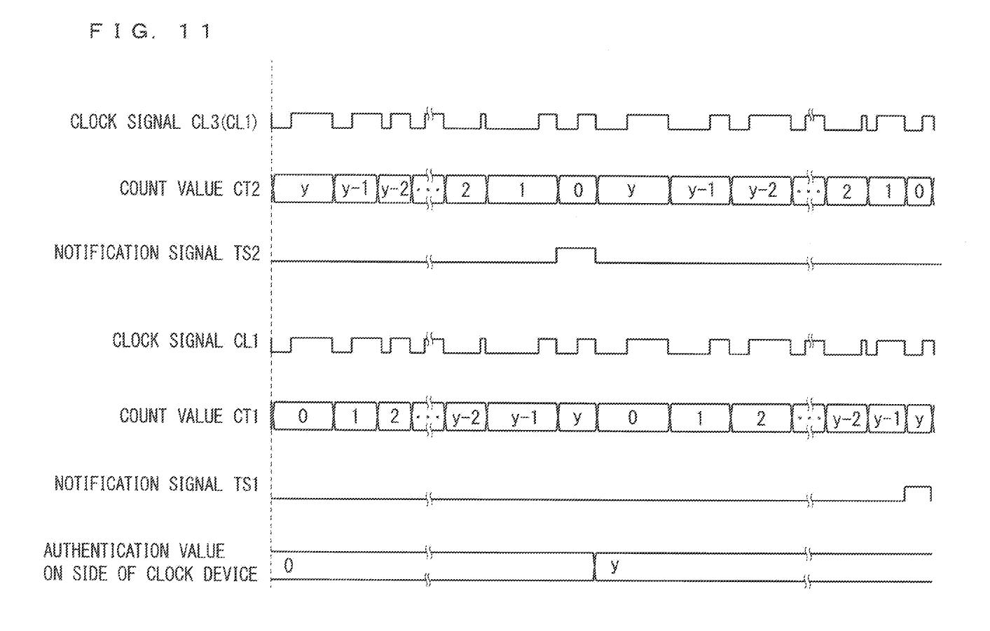

FIG. 11 is a drawing illustrating an example of a timing chart of the electronic apparatus 10A. FIG. 11 illustrates a timing chart in a case where the normal clock signal CL1 is input to the electronic device 5. The counters 33 and 73 are initialized in synchronization with each other first. At this point of time, the authentication value y has not been transmitted to the clock device 1 yet, thus in the illustration in FIG. 11, the authentication value on a side of the clock device 1 at this point of time is indicated by zero.

Next, the authentication unit 8 outputs the notification signal TS2 to the notification signal generation unit 34 via the signal wire L2 in the period of the y^{th} cycle of the clock signal CL3 from the point of time when the counter 73 is initialized. That is to say, the authentication unit 8 outputs the notification signal TS2 in the period when the count amount of the counter 73 coincides with the authentication value y (the period when the count value CT2 takes zero in the example in FIG. 11). The notification signal TS2 may be constituted by 1 bit similar to the notification signal TS1.

The notification signal generation unit 34 recognizes the number of cycles of the clock signal CL1 at the time of receiving the notification signal TS2 as the authentication value y. In other words, the notification signal generation unit 34 recognizes the count amount of the counter 33 at the time of receiving the notification signal TS2 (the count value CT1 in the example in FIG. 11) as the authentication value y.

As illustrated in FIG. 11, if the clock signal CL3 is the normal clock signal CL1, the notification signal generation unit 34 receives the notification signal TS2 in the period when the count value CT1 takes the value y (that is to say, the period of the y^{th} cycle of the clock signal CL1). Thus, the notification signal generation unit 34 can appropriately recognize the authentication value y.

In the illustration in FIG. 11, the authentication value on the side of the clock device 1 is indicated by “y” in the period subsequent to the period when the notification signal TS2 takes H (high). The clock authentication described above is performed in this period.

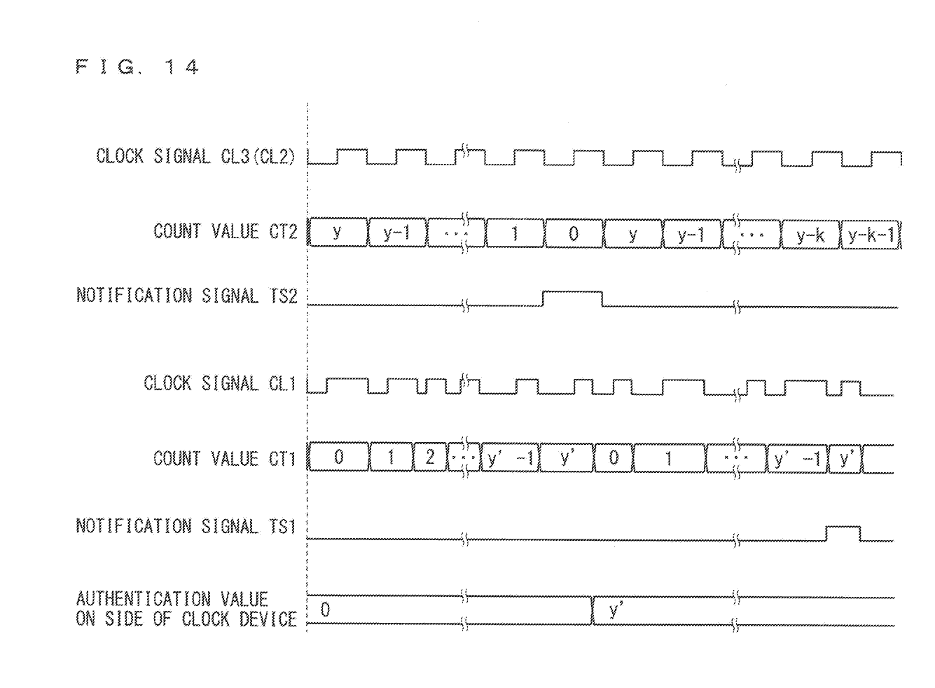

In the meanwhile, if the clock signal CL3 is the illegal clock signal CL2, the notification signal generation unit 34 receives the notification signal TS2 in the period when the count value CT1 takes the value y′ (y′ is a natural number different from y) (that is to say, the period of y′^{th} cycle of the clock signal CL1) (also see FIG. 14). In this case, the notification signal generation unit 34 cannot recognize the authentication value y correctly, but incorrectly recognizes the authentication value y as the value y′.

<Example of Specific Operation>

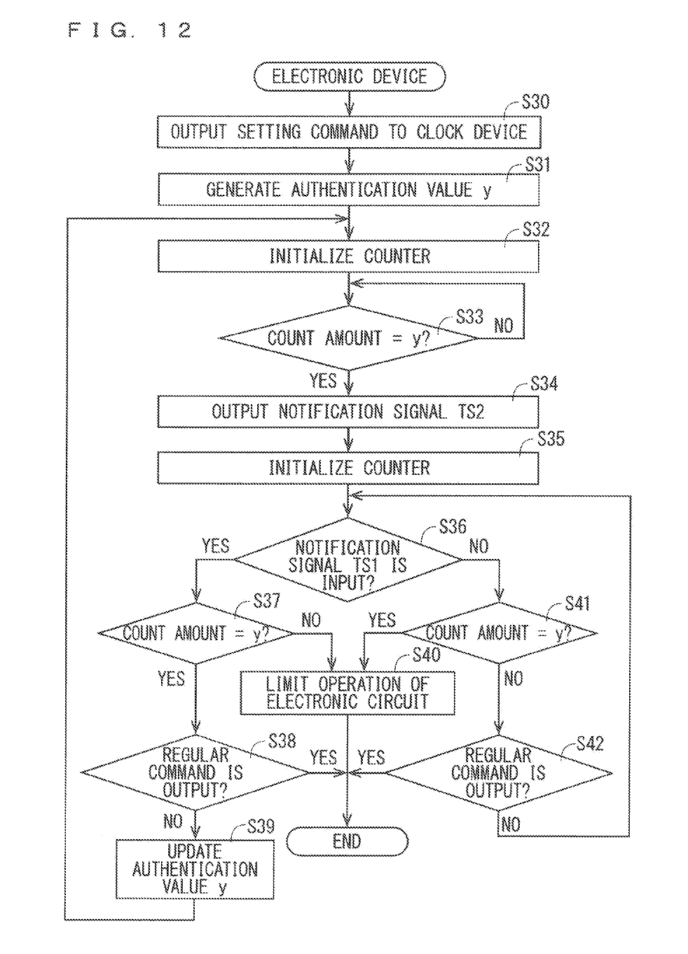

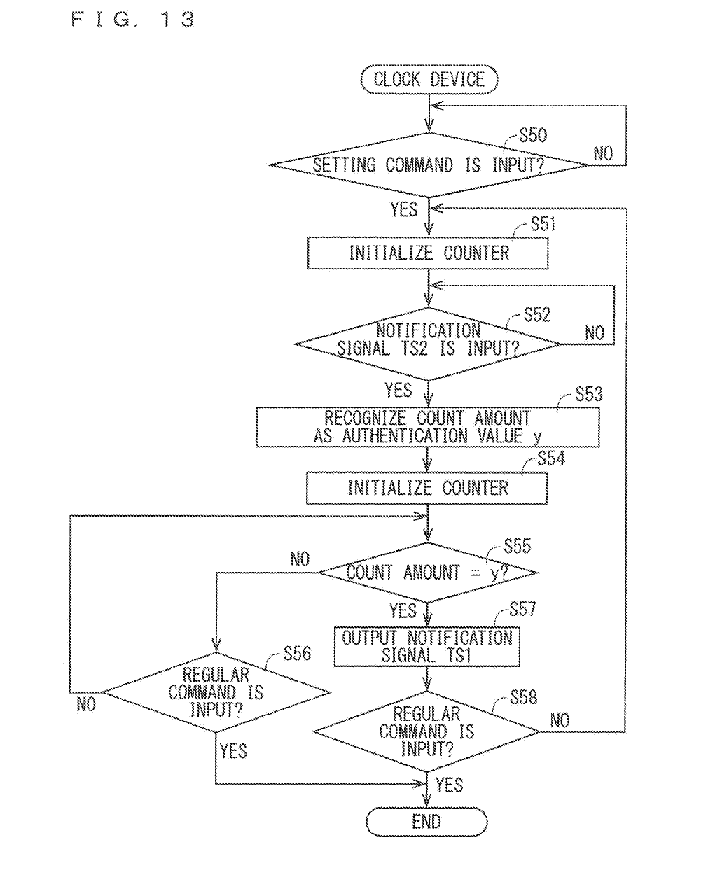

Described next is a more specific example of the sequential operation of the generation and transmission of the authentication value y and the clock authentication. Each of FIG. 12 and FIG. 13 is a flow chart illustrating a specific example of the operation described above of the electronic apparatus 10A. FIG. 12 illustrates an example of the operation of the electronic device 5, and FIG. 13 illustrates an example of the operation of the clock device 1. FIG. 14 is a drawing illustrating an example of a timing chart of the electronic apparatus 10A. FIG. 14 illustrates a timing chart in a case where the illegal clock signal CL2 is input to the electronic device 5.

In Step S30, the electronic circuit 6 outputs the setting command to the clock device 1 first. Next, in Step S31, the random number generation unit 74 generates the random number value as the authentication value y, and outputs the authentication value y to the authentication unit 8. An order of performing Steps S30 and S31 may be reversed. Next, in Step S32, the authentication unit 8 initializes the count value CT2 of the counter 73. In the examples in FIG. 11 and FIG. 14, the count value CT2 is initialized to the authentication value y, and is decremented in each fall of the clock signal CL3.

Next, in Step S33, the authentication unit 8 determines whether or not the count amount of the counter 73 coincides with the authentication value y. Specifically, the authentication unit 8 determines whether or not the count value CT2 of the counter 73 coincides with zero. If the count amount does not coincide with the authentication value y, the authentication unit 8 performs Step S33 again. If the count amount coincides with the authentication value y, the authentication unit 8 outputs the notification signal TS2 to the notification signal generation unit 34 via the signal wire L2 in Step S34. In the examples in FIG. 11 and FIG. 14, the notification signal TS2 takes H (high) in the period when the count value CT2 takes zero.

In accordance with the operation described above, the notification signal TS2 is output in the period of the y^{th} cycle of the clock signal CL3 from the point of time when the counter 73 is initialized.

Next, an example of the operation of the clock device 1 is described. With reference to FIG. 13, the clock device 1 determines whether or not the setting command is input from the electronic circuit 6 in Step S50. If the setting command is not input, the clock device 1 performs Step S50 again. If the setting command is input, the clock device 1 initializes the count value CT1 of the counter 33 in Step S51. The counters 33 and 73 are substantially initialized in accordance with the setting command, thus are initialized in synchronization with each other. In the examples in FIG. 11 and FIG. 14, the count value CT1 is initialized to zero, and is incremented in each fall of the clock signal CL1.

Next, in Step S52, the notification signal generation unit 34 determines whether or not the notification signal TS2 is input from the authentication unit 8 via the signal wire L2. If the notification signal TS2 has not been input yet, the notification signal generation unit 34 performs Step S52 again. If the notification signal TS2 is input, the notification signal generation unit 34 recognizes the count amount of the counter 33 (the count value CT1 herein) as the authentication value y in Step S53.

As illustrated in FIG. 11, if the clock signal CL3 is the normal clock signal CL1, the count value CT1 at the time of outputting the notification signal TS2 coincides with the authentication value y, thus the notification signal generation unit 34 can appropriately recognize the authentication value y. In the meanwhile, as illustrated in FIG. 14, if the clock signal CL3 is the illegal clock signal CL2, the count value CT1 at the time of outputting the notification signal TS2 takes the value y′. Thus, in this case, the notification signal generation unit 34 incorrectly recognizes the authentication value y as the value y′. The authentication value y recognized by the notification signal generation unit 34 is also referred to as the authentication value y1 hereinafter.

In accordance with the operation described above, if the normal clock device 1 is correctly connected to the electronic device 5, the authentication value y can be appropriately transmitted to the notification signal generation unit 34. The transmission of the authentication value y corresponds to the preprocessing of the clock authentication, thus the electronic circuit 6 may output the irregular command after transmitting the authentication value y and subsequently start the confidential processing. According to the configuration described above, the clock authentication described hereinafter can be performed immediately after starting the confidential processing (Steps S35 to S42 and S54 to S58).

In Step S54 subsequent to Step S53, the notification signal generation unit 34 initializes the count value CT1 of the counter 33. In the examples in FIG. 11 and FIG. 14, the count value CT1 is initialized to zero, and is incremented in each fall of the clock signal CL1. Next, in Step S55, the notification signal generation unit 34 determines whether or not the count amount of the counter 33 (the count value CT1 herein) coincides with the authentication value y1.

If the count amount does not coincide with the authentication value y1, the notification signal generation unit 34 determines whether or not the regular command is input from the electronic circuit 6 in Step S56. If the regular command is input, the notification signal generation unit 34 finishes the authentication processing of the clock signal, and if the regular command is not input, the notification signal generation unit 34 performs Step S55 again.

If the count amount coincides with the authentication value y1, the notification signal generation unit 34 outputs the notification signal TS1 to the authentication unit 8 via the signal wire L2 in Step S57. If the clock signal CL3 is the normal clock signal CL1, the notification signal TS1 is output in the period when the count value CT1 coincides with the authentication value y (that is to say, the period of the y^{th} cycle of the clock signal CL1) (FIG. 11). In the meanwhile, if the clock signal CL3 is the illegal clock signal CL2, the notification signal TS1 is output in the period when the count value CT1 coincides with the value y′ (that is to say, the period of the y′^{th} cycle of the clock signal CL1) (FIG. 14).

An example of the operation of the electronic device 5 is described again. With reference to FIG. 12, the authentication unit 8 initializes the count value CT2 of the counter 73 in Step S35 subsequent to Step S34. In the examples in FIG. 11 and FIG. 14, the count value CT2 is initialized to the authentication value y, and is decremented in each fall of the clock signal CL3. The counters 33 and 73 are substantially initialized in response to the notification signal TS2, thus are initialized in synchronization with each other.

Next, in Step S36, the authentication unit 8 determines whether or not the notification signal TS1 is input. If the notification signal TS1 is input, the authentication unit 8 determines whether or not the count amount of the counter 73 coincides with the authentication value y in Step S37. Specifically, the authentication unit 8 determines whether or not the count value CT2 coincides with zero. If the clock signal CL3 is the illegal clock signal CL2, the count amount at the time of inputting the notification signal TS1 does not coincide with the authentication value y (FIG. 14). Thus, at this time, the authentication unit 8 determines that the clock signal CL3 is the illegal clock signal CL2 in Step S40, and limits the operation of the electronic circuit 6. For example, the authentication unit 8 finishes the operation of the electronic circuit 6.

In the example in FIG. 14, the count value CT2 of the counter 73 is larger than zero when the notification signal TS1 is output. That is to say, the notification signal TS1 is output before the count value CT2 of the counter 73 reaches zero. However, the notification signal TS1 is output after the count value CT2 reaches zero in some cases. In other words, the count amount of the counter 73 reaches the authentication value y before the notification signal TS1 is output in some cases. For example, if the cycle of the clock signal CL2 is shorter than the cycle of the clock signal CL1, the count amount of the counter 73 may reach the authentication value y before the notification signal TS1 is output.

Thus, if the authentication unit 8 determines that the notification signal TS1 is not input in Step S36, the authentication unit 8 determines whether or not the count amount of the counter 73 coincides with the authentication value y in Step S41. That is to say, the authentication unit 8 determines whether or not the count amount of the counter 73 coincides with the authentication value y before the notification signal TS1 is input. If the count amount of the counter 73 coincides with the authentication value y, the authentication unit 8 determines that the clock signal CL3 is the illegal clock signal CL2, and performs Step S40.

If the count amount of the counter 73 does not coincide with the authentication value y in Step S41, the authentication unit 8 determines whether or not the regular command is output from the electronic circuit 6 in Step S42. If the regular command is output, the authentication unit 8 finishes the authentication processing of the clock signal, and if the regular command is not output, the authentication unit 8 performs Step S36 again.

If the count amount of the counter 73 coincides with the authentication value y in Step S37, the authentication unit 8 determines that the clock signal CL3 is the normal clock signal CL1, and performs Step S38 without performing Step S40. The authentication unit 8 determines whether or not the regular command is output from the electronic circuit 6 in Step S38. If the regular command is output, the authentication unit 8 finishes the authentication processing of the clock signal, and if the regular command is not output, the authentication unit 8 instructs the random number generation unit 74 to update the authentication value y in Step S39. The random number generation unit 74 generates a new random number value as the authentication value y in response to the instruction, and outputs the authentication value y to the authentication unit 8. It is also applicable that the random number generation unit 74 generates a new random number value before the update instruction, and outputs the new random number value as the authentication value y to the authentication unit 8 in response to the update instruction.

Next, the authentication unit 8 performs Step S32 again using the updated authentication value y. That is to say, if the authentication unit 8 determines that the clock signal CL3 is the normal clock signal CL1, the authentication unit 8 updates the authentication value y and performs the authentication processing of the clock signal again. According to the configuration described above, the random number generation unit 74 updates the authentication value y for each clock authentication, thus the secrecy of the authentication value y can be improved.

As described above, the authentication unit 8 can authenticate the clock signal CL3 based on the input timing of the notification signal TS1 being input from the notification signal generation unit 34. The information amount of the notification signal TS1 can be set to smaller than that of the signal expressing multiple values such as the count value CT1 (or the authentication signalT1). That is to say, the information amount of the signal transmitted from the clock device 1 to the electronic device 5 can be reduced. Thus, the configuration described above contributes to a simplification of the signal wire L2 (for example, a reduction in a total number of signal wires L2).

According to the electronic apparatus 10A, the counters 33 and 73 generate the signal synchronized with the clock signals CL1 and CL3 (the count values CT1 and CT2). The counters 33 and 73 can be made up of a more simple circuit than a random number generation circuit, for example. That is to say, a scale of the circuit of the electronic apparatus 10 can be reduced.

In the example described above, the random number generation unit 74 generates the random value as the authentication value y, thus the authentication value y is randomly generated. Thus, the secrecy of the authentication value y is increased. In the example described above, the authentication value y is updated for each clock authentication. Thus, the secrecy of the authentication value y is further increased.

In the example described above, the authentication unit 8 does not output the authentication value y directly but transmits the authentication value y to the notification signal generation unit 34 using the cycles of the clock signals CL1 and CL3. Thus, the authentication value y can be transmitted with high secrecy. The information amount of the notification signal TS2 can be set to smaller than that of the signal expressing multiple values such as the authentication value y (for example, the random number value). Thus, the authentication value y can be easily transmitted with the small number of signal wires L2. In other words, the configuration described above contributes to the simplification of the signal wire L2 (for example, the reduction in the number of signal wires L2).

<Generation of Authentication Value>

In the example described above, the electronic device 5 transmits the authentication value y to the clock device 1. However, the authentication value y itself needs not be necessarily transmitted. For example, the electronic device 5 may generate a parameter x which is a source of generating the authentication value y and transmit the parameter x to the clock device 1.

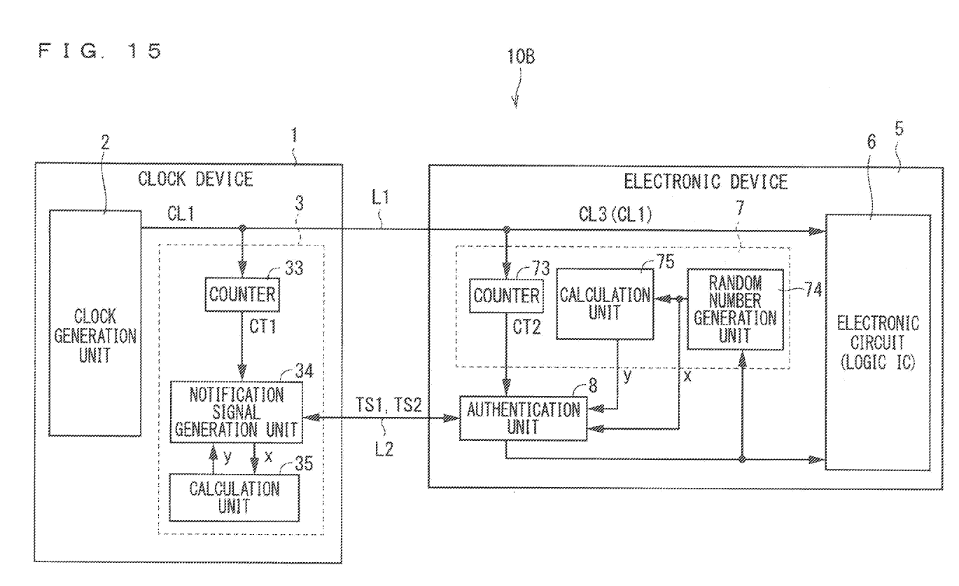

FIG. 15 is a drawing schematically illustrating an example of a configuration of the electronic apparatus 10B. The electronic apparatus 10B is different from the electronic apparatus 10A in an inner configuration of the synchronization signal generation units 3 and 7. The synchronization signal generation unit 3 further includes a calculation unit 35, and the synchronization signal generation unit 7 further includes a calculation unit 75.

The random number generation unit 74 generates the random number value as the parameter x, and outputs the parameter x to the calculation unit 75 and the authentication unit 8. The calculation unit 75, which is a calculation circuit, calculates a predetermined function having the parameter x as the variable to obtain the authentication value y, and outputs the authentication value y to the authentication unit 8. Although the function may be optionally set, it can be expressed by the following equation, for example.

y\hat{ }2=x\hat{ }3+x+1(mod P) (1)

Herein, P is a predetermined value (for example, a prime number), for example.

The authentication unit 8 transmits the parameter x to the notification signal generation unit 34. However, herein, the authentication unit 8 does not directly output the parameter x to the notification signal generation unit 34 but transmits the parameter x using the cycles of the clock signals CL1 and CL3.

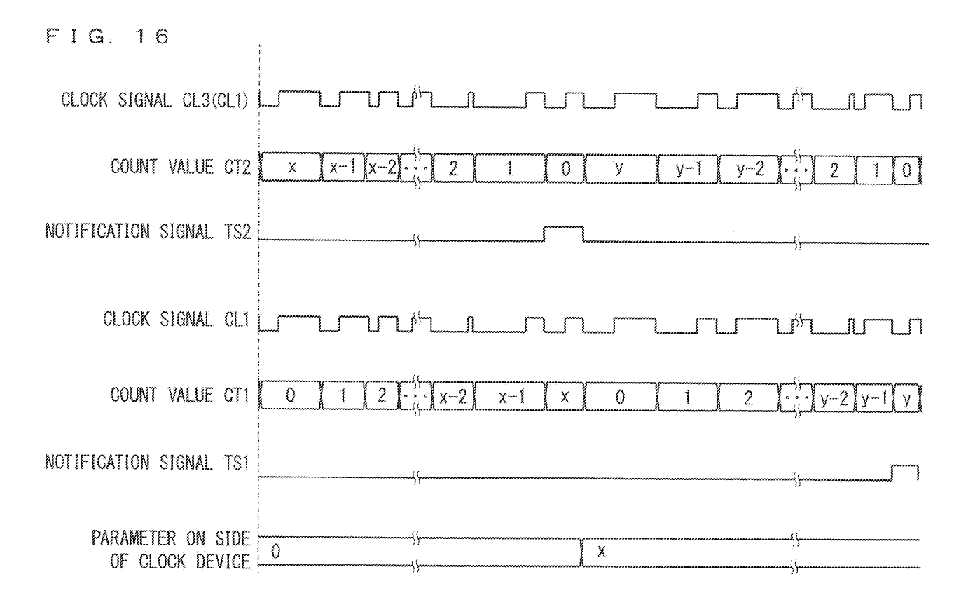

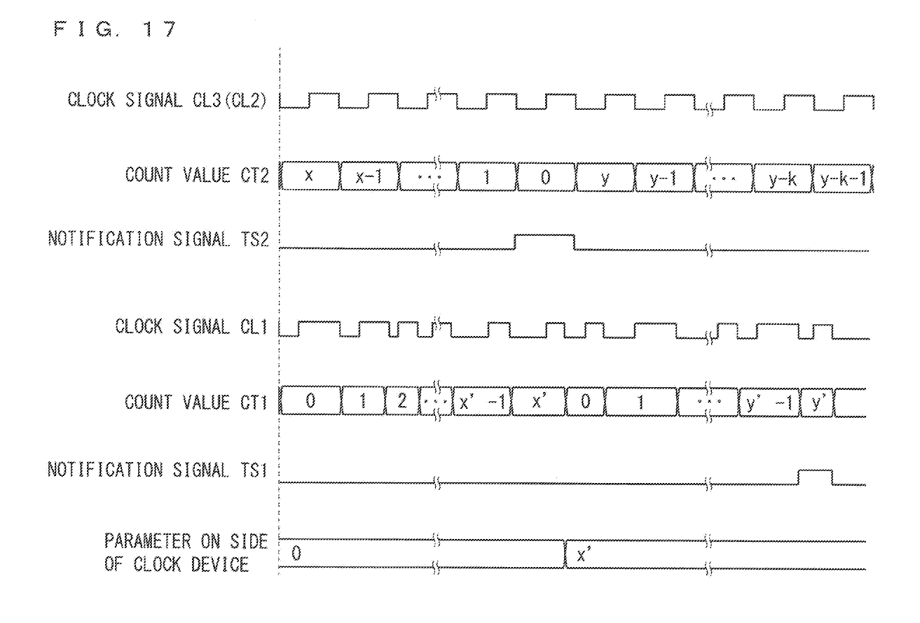

Each of FIG. 16 and FIG. 17 is a drawing illustrating an example of a timing chart of the electronic apparatus 10B. FIG. 16 illustrates a timing chart in a case where the normal clock signal CL1 is input to the electronic device 5, and FIG. 17 illustrates a timing chart in a case where the illegal clock signal CL2 is input to the electronic device 5.

As illustrated in FIG. 16 and FIG. 17, the count values CT1 and CT2 of the counters 33 and 73 are initialized in synchronization with each other. In FIG. 16 and FIG. 17, the count value CT2 is initialized to the parameter x, and is decremented in each fall of the clock signal CL3. The count value CT1 is initialized to zero, and is incremented in each fall of the clock signal CL1.

When the count amount of the counter 73 coincides with the parameter x, that is to say, when the count value CT2 takes zero herein, the authentication unit 8 outputs the notification signal TS2 to the notification signal generation unit 34 via the signal wire L2. The notification signal generation unit 34 recognizes the count amount of the counter 33 at the time of receiving the notification signal TS2 (the count value CT1 herein) as the parameter x.

Thus, if the clock signal CL3 is the normal clock signal CL1, the parameter x is correctly transmitted to the notification signal generation unit 34, and the notification signal generation unit 34 and the authentication unit 8 can recognize the same parameter x (FIG. 16). In the meanwhile, if the clock signal CL3 is the illegal clock signal CL2, the notification signal generation unit 34 incorrectly recognizes the parameter x as the value x′ (FIG. 17).

The notification signal generation unit 34 outputs the parameter x to the calculation unit 35. The calculation unit 35 is the same arithmetic circuit as the calculation unit 75. The calculation unit 35 calculates the function having the parameter x as the variable, which is the same as that in the calculation unit 75, to obtain the authentication value y, and outputs the authentication value y to the notification signal generation unit 34. If the clock signal CL3 is the normal clock signal CL1, the parameters x being input to the calculation units 35 and 75 are equal to each other, thus the authentication values y being output from the calculation units 35 and 75 are also equal to each other. In the meanwhile, if the clock signal CL3 is the illegal clock signal CL2, the value x′ is input to the calculation unit 35 as the parameter x, and the parameter x is input to the calculation unit 75. Thus, even if the calculation units 35 and 75 perform the same algorithm, the authentication values y being output from them are different from each other. The authentication value y recognized by the notification signal generation unit 34 is also referred to as the authentication value y1 hereinafter.

If the authentication value y is recognized by both the notification signal generation unit 34 and the authentication unit 8, the count values CT1 and CT2 of the counters 33 and 73 are initialized in synchronization with each other again. In the examples in FIG. 16 and FIG. 17, the count values CT1 and CT2 are initialized to zero and the authentication value y, respectively, immediately after the period when the notification signal TS2 takes H.

When the count amount of the counter 33 coincides with the authentication value y1, the notification signal generation unit 34 outputs the notification signal TS1 to the authentication unit 8 via the signal wire L2. tThe authentication unit 8 determines whether or not the notification signal TS1 is input when the count amount of the counter 73 coincides with the authentication value y. If the notification signal TS1 is input in the state where the count amount of the counter 73 coincides with the authentication value y, the authentication unit 8 determines that the clock signal CL3 is the normal clock signal CL1. In the example in FIG. 16, when the count value CT2 takes zero, that is to say, when the count amount of the counter 73 coincides with the authentication value y, the notification signal TS1 is input to the authentication unit 8. Thus, at this time, the authentication unit 8 determines that the clock signal CL3 is the normal clock signal CL1.

In the meanwhile, if the notification signal TS1 is not input in the state where the count amount of the counter 73 coincides with the authentication value y, the authentication unit 8 determines that the clock signal CL3 is the illegal clock signal CL2. In the example in FIG. 17, the notification signal generation unit 34 incorrectly recognizes the authentication value y as the value y′, thus the notification signal generation unit 34 outputs the notification signal TS1 when the count amount of the counter 33 coincides with the value y′. At this time, the count value CT2 does not normally take zero (that is to say, the count amount of the counter 73 does not coincide with the authentication value y). Thus, the authentication unit 8 determines that the clock signal CL3 is the illegal clock signal CL3, and limits the operation of the electronic circuit 6.

As described above, the electronic apparatus 10B can also authenticate the clock signal CL3. Furthermore, the authentication value y is generated by the calculation unit 35 in the clock device 1 and the calculation unit 75 in the electronic device 5. Thus, even if the illegal third party monitors the signal wire L2 between the clock device 1 and the electronic device 5, thereby being able to acquire the parameter x illegally, the third party cannot acquire the authentication value y as long as the third party does not know the algorithm of the calculation units 35 and 75. Thus, the secrecy of the authentication value y can be further increased.

As described above, the electronic apparatus 10 has been shown and described in detail, the foregoing description is in all aspects illustrative, thus the present invention is not limited thereto. The embodiments described above can be implemented in combination as long as they are not mutually inconsistent. Various modifications not exemplified are construed to be made without departing from the scope of the electronic apparatus 10.

What is claimed is:

1. An electronic apparatus with a clock authentication function, comprising:
a first signal wire for a clock;
a clock device including a clock generation unit containing circuitry configured to output a clock signal to the first signal wire and a first signal generation unit containing circuitry configured to generate a first signal being synchronized with a clock signal being generated by the clock generation unit;
an electronic device including an electronic circuit to which a clock signal is input via the first signal wire and a second signal generation unit containing circuitry configured to generate a second signal being synchronized with a clock signal being input to the electronic circuit; and
an authentication unit including circuitry configured to authenticate a clock signal being input to the electronic circuit based on whether or not the first signal and the second signal are synchronized with each other.

2. The electronic apparatus with the clock authentication function according to claim 1, wherein
the first signal generation unit includes a first counter which counts a clock signal being generated by the clock generation unit and outputs a count value of the clock signal as the first signal, and
the second signal generation unit includes a second counter which is initialized in synchronization with the first counter, counts a clock signal being input to the electronic circuit, and outputs a count value of the clock signal as the second signal.

3. The electronic apparatus with the clock authentication function according to claim 2, wherein
the clock device and the electronic device are connected to each other via a second signal wire,
the authentication unit belongs to the electronic device,
the first signal generation unit includes a notification signal generation unit containing circuitry configured to generate a first notification signal when a count amount of the first counter coincides with an authentication value, and to output the first notification signal to the authentication unit via the second signal wire, and
the authentication unit determines that the clock signal being input to the electronic circuit is illegal if a count amount of the second counter at a time of inputting the first notification signal does not coincide with the authentication value or if the first notification signal has not been input yet when a count amount of the second counter coincides with the authentication value.

4. The electronic apparatus with the clock authentication function according to claim 3, wherein
the authentication unit determines that the clock signal being input to the electronic circuit is a normal clock signal if a count amount of the second counter at a time of inputting the first notification signal coincides with the authentication value.

5. The electronic apparatus with the clock authentication function according to claim 3, wherein
the second signal generation unit includes a random number generation unit containing circuitry configured to generate a random number value as the authentication value, and
the authentication unit outputs the random number value being input from the random number generation unit to the notification signal generation unit via the second signal wire.

6. The electronic apparatus with the clock authentication function according to claim 3, wherein
the second signal generation unit includes:
a random number generation unit containing circuitry configured to generate a random number value; and
a first calculation unit containing circuitry configured to generate a value of a predetermined function which includes the random number value as a variable, as the authentication,
the authentication unit outputs the random number value being input from the random number generation unit to the notification signal generation unit via the second signal wire, and
the first signal generation unit includes a second calculation unit containing circuitry configured to generate a value of a predetermined function which includes the random number value as a variable, as the authentication value.

7. The electronic apparatus with the clock authentication function according to claim 5, wherein
the authentication unit outputs a second notification signal to the notification signal generation unit via the second signal wire when a count amount of the second counter coincides with the random number value, and
the notification signal generating unit recognizes a count amount of the second counter at a time of inputting the second notification signal as the random number value.

8. The electronic apparatus with the clock authentication function according to claim 3, wherein
the authentication value is updated for each authentication of a clock signal.

9. The electronic apparatus with the clock authentication function according to claim 1, wherein
the first signal generation unit includes:
a first pseudorandom number generation unit containing circuitry configured to generate a pseudorandom number value as the first signal; and
a first setting value generating unit containing circuitry configured to generate a common key as an initial setting value of the first pseudorandom number generation unit using a predetermined key generation algorithm, and
the second signal generation unit includes:
a second pseudorandom number generation unit containing circuitry configured to generate a pseudorandom number value as the second signal; and
a second setting value generating unit containing circuitry configured to generate a common key as an initial setting value of the second pseudorandom number generation unit using the predetermined key generation algorithm.

10. The electronic apparatus with the clock authentication function according to claim 9, wherein
the electronic circuit performs normal processing and confidential processing which uses confidential information having higher secrecy than information used in the normal processing, and
the electronic circuit starts the confidential processing after the first setting value generating unit and the second setting value generation unit generate the initial setting value.

11. The electronic apparatus with the clock authentication function according to claim 1, wherein
the electronic circuit performs normal processing and confidential processing which uses confidential information having higher secrecy than information used in the normal processing, and
the authentication unit authenticates a clock signal being input to the electronic circuit when the electronic circuit performs the confidential processing.

12. The electronic apparatus with the clock authentication function according to claim 1, wherein
when the authentication unit determines that a clock signal being input to the electronic circuit is illegal, the authentication unit limits an operation of the electronic circuit.

13. An authentication method of a clock signal in an electronic apparatus including a clock device and an electronic device being connected to each other via a first signal wire, comprising:
a step that a clock generation unit of the clock device outputs a clock signal to a first signal wire,
a step that a first synchronization signal generation unit of the clock device generates a first signal being synchronized with a clock signal being generated by the clock generation unit,
a step that an electronic circuit of the electronic device operates based on a clock signal being input via the first signal wire,
a step that a second synchronization signal generation unit of the electronic device generates a second signal being synchronized with a clock signal being input to the electronic circuit, and
a step that a clock signal being input to the electronic circuit is authenticated based on whether or not the first signal and the second signal are synchronized with each other.
